(19) United States
(12) Patent Application Publication
(10) Pub. No.: US 2008/0244082 A1
(43) Pub. Date: Oct. 2, 2008

(54) CONTENTS COMMUNICATION METHOD FOR TRANSMITTING CONTENTS BY USING A PREDETERMINED COMMUNICATION PROTOCOL, AND CONTENTS TRANSMITTING APPARATUS AND CONTENTS RECEIVING APPARATUS USING THE METHOD

(76) Inventors: Haoming Shen, Ichinomiya-shi (JP); Yoshinori Hatayama, Komaki-shi (JP)

Correspondence Address: MCDERMOTT WILL & EMERY LLP, 600 13TH STREET, N.W., WASHINGTON, DC, 20005-3096, US

(21) Appl. No.: 11/956,967

(22) Filed: Dec. 14, 2007

(30) Foreign Application Priority Data
Dec. 15, 2006 (JP) 2006-339128
Nov. 5, 2007 (JP) 2007-287099
Dec. 13, 2007 (JP) 2007-321645

(51) Int. Cl. G06F 15/16

(52) U.S. Cl. 709/232

(57) ABSTRACT

A player receives, via a network, contents transmitted by a targeted server. A network detection unit detects the number of servers and the number of other players in operation on the network. A receiving control unit selects, as a communication scheme used between the player and the targeted server, any one of a scheme where a push-based communication is fixedly used, a scheme where a pull-based communication is fixedly used and a scheme where the push-based communication and the pull-based communication are dynamically switched, based on the number of servers and the number of other players detected by the network detection unit. A contents receiver receives the contents transmitted by the targeted server according to a selected result.

### CROSS-REFERENCE TO RELATED APPLICATIONS

This application is based upon and claims the benefit of priority from the prior Japanese Patent Application No. 2006-339128, filed on Dec. 15, 2006, Japanese Patent Application No. 2007-287099, filed on Nov. 5, 2007, and Japanese Patent Application No. 2007-321645, filed on Dec. 13, 2007, the entire contents of which are incorporated herein by reference.

### BACKGROUND OF THE INVENTION

1. Field of the Invention

The present invention relates to a contents communication technology, and it particularly relates to a contents method for transmitting the contents by using a predetermined communication protocol, and a contents transmitting apparatus and a contents receiving apparatus utilizing said method.

2. Description of the Related Art

Communication protocols used to transmit contents in a network generally contain pull-based communications and push-based communications. The push-based communication is a mode where a transmitting side immediately transmits data if the data can be prepared at a transmitting side. The pull-based communication is a mode where the receiving side requests the transmitting side to send the data while taking account of its own throughput. These are defined as independent protocols and no technology capable of mixing them both and operating it in working order has been defined. In order to support these two kinds of communication schemes, it is conceivable that a player functioning as a contents receiving apparatus and a server functioning as a contents transmitting apparatus are each equipped with the both schemes.

Even in such a conceivable scheme, the player cannot play the contents if the push-based communication is to be performed on the same player from the server in the middle of retrieval and playback of the contents from the server by using the pull-based communication. Also, when the two kinds of communications are operated simultaneously in equipment such as a mobile phone device and a digital camera, scarce resources and communication bands in the equipment are wasted. Accordingly, it is preferable that the communication schemes be dynamically switched as necessary. For example, a method has been proposed where a communication mode is selected by presenting a menu to a user.

However, when the user selects a communication scheme based on the menu, a user needs to select it manually and also the user needs to configure pairing between the server and the player beforehand. This complicates the operation. In consideration of user convenience, a plurality of communication schemes need to be switched without making a user conscious of the communication scheme in present use. That is, it is desirable that the communication schemes be automatically switched according to a network configuration and a transmission operation instructed by the user.

### SUMMARY OF THE INVENTION

The present invention has been made in view of such circumstances and a general purpose thereof is to provide a contents communication technology by which to switch communication schemes in a simplified manner at the time of transmission of the contents.

In order to resolve the above problems, a contents receiving apparatus for receiving, via a network, contents transmitted by a targeted contents transmitting apparatus, according to one embodiment of present invention comprises: a detector which detects the number of contents transmitting apparatuses and the number of other contents receiving apparatuses in operation on the network; a selector which selects, as a communication scheme used between the contents receiving apparatus and the targeted contents transmitting apparatus, any one of a scheme where a push-based communication is fixedly used, a scheme where a pull-based communication is fixedly used and a scheme where the push-based communication and the pull-based communication are dynamically switched therebetween, based on the number of contents transmitting apparatuses and the number of other contents receiving apparatuses detected by the detector; and an execution unit which receives the contents transmitted by the targeted contents transmitting apparatus according to a result selected by the selector.

“Contents” corresponds to video data, audio data, information data contained in a program, respectively, or an arbitrary combination thereof. The “contents” may be video data and the like themselves or those obtained after the video data and the like have undergone a processing such as coding. According to this embodiment, the communication scheme between a contents transmitting apparatus and a contents receiving apparatus is selected according to the number of transmitting apparatuses and the number of receiving apparatuses in operation on the network. Thus, the communication scheme used when the contents are received can be switched in a simplified manner.

When a plurality of contents transmitting apparatuses are detected by the detector, the selector may select the scheme where a pull-based communication is fixedly used, and the execution unit may instruct the targeted contents transmitting apparatus to transmit the contents. In such a case, when a plurality of contents transmitting apparatus are detected, the pull-based communication is fixedly used. Thus, disruption and confusion caused by the push-based communication simultaneously performed from a plurality of contents transmitting apparatuses can be prevented.

When a single contents transmitting apparatus and at least one other contents receiving apparatus are detected by the detector, the selector may select the scheme where a push-based communication is fixedly used. In such a case, when there are a single contents transmitting apparatus and a plurality of contents receiving apparatuses, the push-based communication is used. Thus the disruption and confusion can be prevented by performing communication under control of a single contents transmitting apparatus.

The contents receiving apparatus may further comprise: a first receiving unit which receives an instruction from a user; and a second receiving unit which receives from a targeted contents transmitting apparatus an instruction on a communication scheme to be executed, wherein when a single contents transmitting apparatus is detected and other contents receiving apparatuses are not detected by the detector, the selector may select the scheme where the push-based communication and the pull-based communication are dynamically switched therebetween, and wherein when the scheme where the push-based communication and the pull-based communication are dynamically switched therebetween is selected by the selector and the instruction is received by the first receiving unit, the execution unit may execute the pull-based communication as the communication scheme; and when the scheme where the push-based communication and the pull-based communication are dynamically switched therebetween is selected by the selector and the instruction is received by the second receiving unit, the execution unit may execute the push-based communication as the communication scheme. In this case, the push-based communication and the pull-based communication are dynamically switched therebetween according to instructions. Thus, various use cases can be flexibly dealt with.

Another embodiment of the present invention relates to a contents transmitting apparatus for transmitting contents to a targeted contents receiving apparatus via a network. This apparatus comprises: a detector which detects the number of contents receiving apparatuses and the number of other contents transmitting apparatuses in operation on the network; a selector which selects, as a communication scheme used between the contents transmitting apparatus and the targeted contents receiving apparatus, any one of a scheme where a push-based communication is fixedly used, a scheme where a pull-based communication is fixedly used and a scheme where the push-based communication and the pull-based communication are dynamically switched therebetween, based on the number of contents receiving apparatuses and the number of other contents transmitting apparatuses detected by the detector; and an execution unit which transmits the contents to the targeted contents receiving apparatus according to a result selected by the selector.

By employing this embodiment, the communication scheme used between the contents transmitting apparatus and the contents receiving apparatus is selected according to the number of contents transmitting apparatuses and the number of contents receiving apparatuses in operation on the network. Hence, the communication scheme used when the contents are transmitted can be switched in a simplified manner.

When another contents transmitting apparatus is detected by the detector, the selector may select the scheme where a pull-based communication is fixedly used, and the execution unit may transmit the contents according to an instruction from the targeted contents receiving apparatus. In such a case, when a plurality of contents transmitting apparatus are detected, the pull-based communication is fixedly used. Thus, disruption and confusion caused by the push-based communication simultaneously performed from a plurality of contents transmitting apparatuses can be prevented.

When any other contents transmitting apparatus is not detected and a plurality of contents receiving apparatuses are detected by the detector, the selector may select the scheme where a push-based communication is fixedly used. In such a case, when there are a single contents transmitting apparatus and a plurality of contents receiving apparatuses, the push-based communication is used. Thus the disruption and confusion can be prevented by performing communication under control of a single contents transmitting apparatus.

The contents transmitting apparatus may further comprise: a first receiving unit which receives an instruction from a user; and a second receiving unit which receives from a targeted contents receiving apparatus an instruction on a communication scheme to be executed, wherein when any other contents transmitting apparatus is not detected and a single receiving apparatus is detected by the detector, the selector may select the scheme where the push-based communication and the pull-based communication are dynamically switched therebetween, and wherein when the scheme where the push-based communication and the pull-based communication are dynamically switched therebetween is selected by the selector and the instruction is received by the first receiving unit, the execution unit may execute the push-based communication as the communication scheme; and when the scheme where the push-based communication and the pull-based communication are dynamically switched therebetween is selected by the selector and the instruction is received by the second receiving unit, the execution unit may execute the pull-based communication as the communication scheme. In this case, the push-based communication and the pull-based communication are dynamically switched therebetween according to instructions. Thus, various use cases can be flexibly dealt with.

Still another embodiment of the present invention relates to a contents communication method. This method is such that any one of a scheme where a push-based communication is fixedly used, a scheme where a pull-based communication is fixedly used and a scheme where the push-based communication and the pull-based communication are dynamically switched therebetween is selected as a communication scheme used when contents are transmitted from a contents transmitting apparatus to a contents receiving apparatus, based on the number of contents transmitting apparatuses and the number of other contents receiving apparatuses in operation on a network.

Still another embodiment of the present invention relates also to a contents receiving apparatus. This apparatus is a contents receiving apparatus for receiving, via a network, contents transmitted by a targeted contents transmitting apparatus, and it comprises: a detector which detects the number of contents transmitting apparatuses and the number of other contents receiving apparatuses in operation on the network; a selector which selects, as a communication scheme used between the contents receiving apparatus and the targeted contents transmitting apparatus, any one of a scheme where a first pull-based communication started by the contents transmitting apparatus is fixedly used, a scheme where a second pull-based communication started by the contents receiving apparatus is fixedly used, and a scheme where the first pull-based communication and the second pull-based communication are dynamically switched therebetween; and an execution unit which receives the contents transmitted by the targeted contents transmitting apparatus according to a result selected by the selector.

Still another embodiment of the present invention relates also to a contents transmitting apparatus. This apparatus is a contents transmitting apparatus for transmitting contents to a targeted contents receiving apparatus via a network and it comprises: a detector which detects the number of contents receiving apparatuses and the number of other contents transmitting apparatuses in operation on the network; a selector which selects, as a communication scheme used between the contents transmitting apparatus and the targeted contents receiving apparatus, any one of a scheme where a first pull-based communication started by the contents transmitting apparatus is fixedly used, a scheme where a second pull-based communication started by the contents receiving apparatus is fixedly used, and a scheme where the first pull-based communication and the second pull-based communication are dynamically switched therebetween, based on the number of contents receiving apparatuses and the number of other contents transmitting apparatuses detected by the detector; and an execution unit which transmits the contents to the targeted contents receiving apparatus according to a result selected by the selector.

Still another embodiment of the present invention relates also to a contents communication method. This method is such that any one of a scheme where a first pull-based communication started by a contents transmitting apparatus is fixedly used, a scheme where a second pull-based communication started by a contents receiving apparatus is fixedly used, and a scheme where the first pull-based communication and the second pull-based communication are dynamically switched therebetween is selected as a communication scheme used when contents are transmitted from the contents transmitting apparatus to the contents receiving apparatus, based on the number of contents transmitting apparatuses and the number of other contents receiving apparatuses in operation on a network.

Optional combinations of the aforementioned constituting elements, and implementations of the invention in the form of methods, apparatuses, systems, recording mediums, computer programs and so forth may also be practiced as additional modes of the present invention.

### BRIEF DESCRIPTION OF THE DRAWINGS

Embodiments will now be described by way of examples only, with reference to the accompanying drawings which are meant to be exemplary, not limiting, and wherein like elements are numbered alike in several Figures in which:

FIG. 1 illustrates a structure of a contents communication system according to an exemplary embodiment of the present invention;

FIG. 2 illustrates a data structure of a device list in a device list storage as shown in FIG. 1;

FIGS. 3A to 3D illustrate an outline of operations according to communication schemes in a contents communication system as shown in FIG. 1;

FIGS. 4A and 4B illustrate data structures of switching rules stored in switching rule storages as shown in FIG. 1;

FIG. 5 is a flowchart showing a management procedure performed by a device management unit as shown in FIG. 1;

FIG. 6 is a flowchart showing an analysis procedure performed by network analysis units as shown in FIG. 1;

FIG. 7 is a flowchart showing a control procedure performed by switching control units as shown in FIG. 1;

FIG. 8 is a flowchart showing an operational procedure performed when a “first-come first served” mode is set by a player of FIG. 1:

FIG. 9 is a flowchart showing an operational procedure performed when a “first-come first served” mode is set by a server of FIG. 1;

FIGS. 10A and 10B illustrate an outline of operation carried out when a “first-come first-served” mode is set in Case 4 of FIG. 3D;

FIG. 11 illustrates a structure of a contents communication system according to a modification of an exemplary embodiment;

FIG. 12 illustrates a structure of a contents communication system according to still another modification of an exemplary embodiment;

FIG. 13 illustrates a data structure of a device list stored in a device list storage according to still another modification of an exemplary embodiment;

FIG. 14 is a flowchart showing an analysis procedure performed by a network analysis unit according to still another modification of an exemplary embodiment; and

FIG. 15 illustrates a structure of a contents communication system according to still another modification of an exemplary embodiment.

### DETAILED DESCRIPTION OF THE INVENTION

The invention will now be described by reference to the preferred embodiments. This does not intend to limit the scope of the present invention, but to exemplify the invention.

An outline of the present invention will be given before a specific description thereof. Exemplary embodiments of the present invention relate to a contents communication system comprised of a server and a player connected via a network. In the contents communication system, the server stores contents beforehand and transmits the contents to the player via the network. When the player receives the contents, it plays back the contents. Here, a pull-based communication and a push-based communication are generally defined and provided as communication schemes used to transmit the contents between the server and the player. In order to be compatible with these communication schemes, the server and the player are each provided with a control module and a user interface required by the both schemes. However, these two schemes are not compatible with each other, so that the server and player require a function by which to switch the communication scheme. In consideration of the user convenience, it is desired that such a switching function be performed with ease.

The server and the player according to the present exemplary embodiment each detects automatically the configuration of the network by monitoring the execution status of the other apparatus. Based on information on the configuration, the server and the player each determines the communication scheme. Then the server and the player each switches the communication scheme of its system to the pull-based communication or push-based communication by starting or stopping the control module and the user interface provided in its own device. The server and the player each automatically selects a communication scheme desired by a user in consideration of user's operations, too.

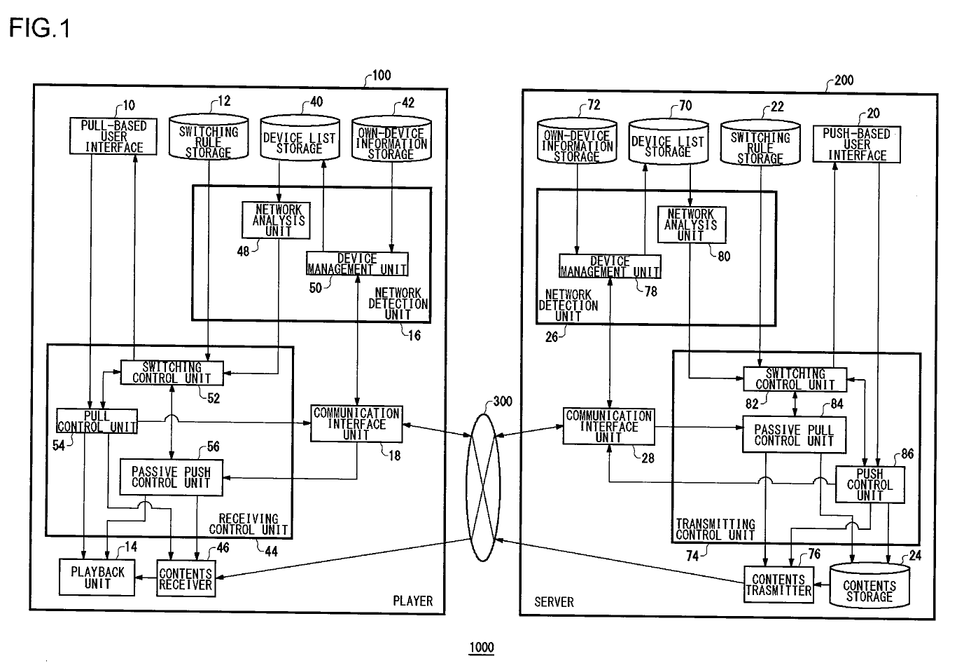

FIG. 1 illustrates a structure of a contents communication system 1000 according to an exemplary embodiment of the present invention. The contents communication system 1000 includes a player 100, a server 200, and a network 300. The player 100 includes a pull-based user interface unit 10, a switching rule storage 12, a device list storage 40, a own-device information storage 42, a network detection unit 16, a receiving control unit 44, a communication interface unit 18, a playback unit 14, and a contents receiver 46. The receiving control unit 44 includes a switching control unit 52, a pull control unit 54, and a passive push control unit 56. The network detection unit 16 includes a network analysis unit 48 and a device management unit 50.

The server 200 includes a push-based user interface unit 20, a switching rule storage 22, a device list storage 70, an own-device information storage 72, a network detection unit 26, a transmitting control unit 74, a communication interface unit 28, a contents transmitter 76, and a contents storage 24. The network detection unit 26 includes a device management unit 78 and a network analysis unit 80. The transmitting control unit 74 includes a switching control unit 82, a passive pull control unit 84, and a push control unit 86. In the following description, the player 100 and the server 200 are generically referred to as “device” or “equipment” on some occasions.

In the contents communication system 1000 as shown in FIG. 1, two kinds of devices, namely the player 100 and the server 200, are connected via the network 300 and communicate with each other, so that the contents are transmitted therebetween. However, a plurality of players 100 or a plurality of servers 200 may be connected via the network 300. Here, the server 200 stores contents and transmits the contents to a targeted player 100 via the network 300. On the other hand, the player 100 receives via the network 300 the contents transmitted by a server 200 to be communicated, and plays the received contents. Note that the network 300 may be a wired network or wireless network or a combination of the both.

The own-device information storage 72 stores equipment information including the equipment ID, model, model number and maker of its own equipment. The model indicates either a player 100 or a server 200, so that the own-device information storage 72 stores information indicating that it is a server 200. The network detection unit 26 detects the number of players 100 and the number of other servers 200 operating on the network 300. The network detection unit 26 outputs the configuration of the network 300 to the transmitting control unit 74.

In the network detection unit 26, the device management unit 78 manages information on its own device and a device list discussed later. The device management unit 78 reads out the information on its own device and then notifies the information on its own device on the network 30 via the communication interface unit 28. The device management 78 also gathers the device information on other devices on the network 300, via the communication interface unit 28. Based on the device information gathered, the device management unit 78 updates the device list stored in the device list storage 70.

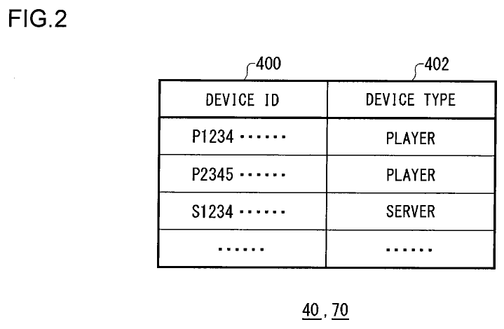

The device list storage 70 stores information on the player 100 and the server 200 operating on the network 300. The device storage 40 which will be discussed later operates and is structured the same way as the device list storage 70. FIG. 2 illustrates a data structure of a device list in the device list storages 40 and 70. Here, a device list is a data structure for storing device information on the player 100 and the server 200 connected to the network 300. As shown in FIG. 2, one example of the device list includes a device ID column 400 and a device type column 402. Device IDs contained in the device ID column 400 correspond to unique identification codes allocated to a network device. Whether an applicable device is a player 100 or a server 200 is indicated in items contained in the device type column 402. Refer back to FIG. 1.

The network analysis unit 80 analyzes the structure of the network 300. More specifically, the network analysis unit 80 derives the number of players 100 and the number of servers 200 in operation on the network 300 by referring to the device list stored in the device list storage 70, thereby deriving the configuration of the network 300. Further, the network analysis unit 80 outputs the thus derived result to the control unit 74.

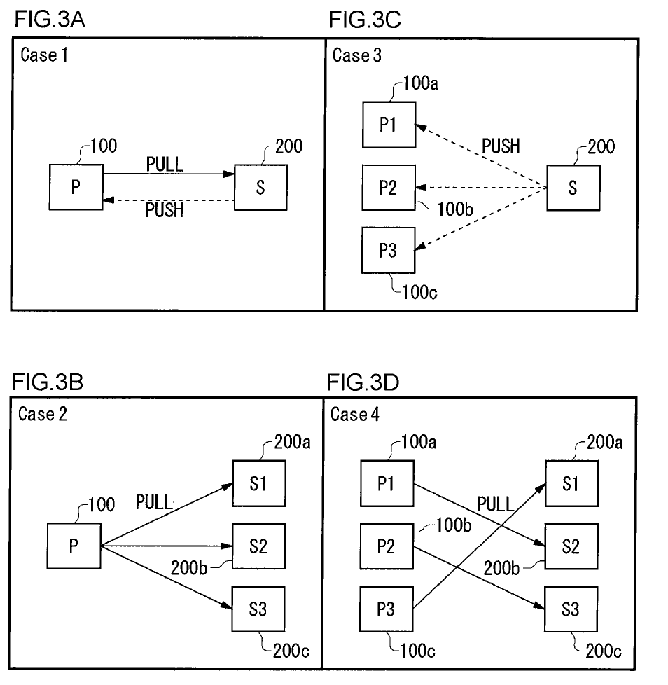

According to the structure of the network 300 analyzed by the network analysis unit 80, a rule concerning a communication scheme to be employed is stored in the switching rule storage 22. The switching rule storage 12 which will be discussed later operates and is structured the same way as the device list storage 70. An outline of the operation of communication schemes defined as a rule is described before describing the data structure of rules stored in the switching rule storage 22. FIGS. 3A to 3D illustrate an outline of operations according to communication schemes in the contents communication system 1000. In FIGS. 3A to 3D, the player 100 is indicated as “P” and the server “S”.

FIG. 3A is “Case 1” where there is a single player 100 and there is a single server 200. In “Case 1”, the communication scheme is dynamically determined according to the user's operation. This communication scheme will be hereinafter referred to as “first-come first-served” mode. In the “first-come first-served” mode, the pull-based communication and the push-based communication are both set to a usable state. In such a state where the both communication schemes are usable, when one of them is started to perform communication as in a case, for example, when a user presses down on a “transmit” button on an operation menu, the execution of the other communication scheme is prohibited. And when the communication has been completed, the other communication scheme is returned again to the usable state. Hence, the communication scheme is switched between the pull-based and the push-based communication to suit the needs of the user.

FIG. 3B is “Case 2” where there is a single player 100 and there are a plurality of servers 200. In “Case 2”, the pull-based communication is forcibly executed as a communication scheme for the system, whereas the push-based communication is prohibited. By making decisions as described above, the disruption in the player 100 in the case that the push-based communication is executed from a plurality of servers 200 to a single player 100 simultaneously can be prevented.

FIG. 3C is “Case 3” where there are a plurality of players 100 and there is a single server 200. In “Case 3”, the push-based communication is forcibly executed as a communication scheme for the system, whereas the pull-based communication is prohibited. This usage is particularly suitable for a mobile server apparatus such as a digital camera or mobile telephone unit. FIG. 3D is “Case 4” where there are a plurality of players 100 and there are also a plurality of servers 200. In “Case 4”, similar to “Case 2”, the pull-based communication is forcibly executed and the push-based communication is prohibited.

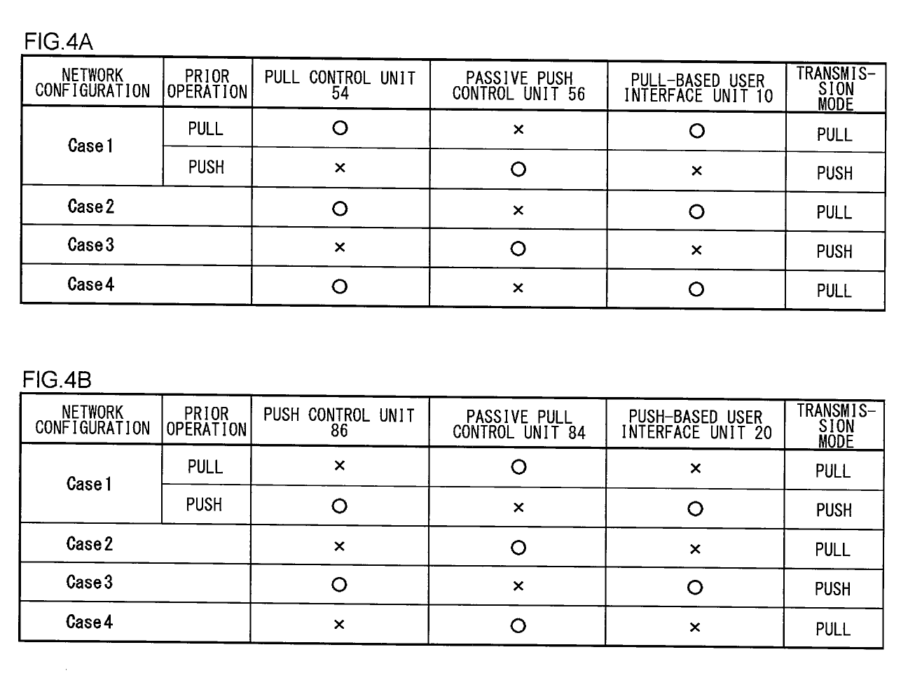

FIGS. 4A and 4B illustrate data structures of switching rules stored in the switching rule storages 12 and 22. FIG. 4A corresponds to a switching rule stored in the switching rule storage 12, whereas FIG. 4B a switching rule stored in the switching rule storage 22. The elements to be operated and the elements to be stopped are indicated corresponding respectively to “Case 1” through “Case 4”. The switching rules stored in the switching rule storage 12 determines the operating states of the pull control unit 54, the passive push control unit 56 and the pull-based user interface unit 10, whereas the switching rules stored in the switching rule storage 22 determines the operating states of the push control unit 86, the passive pull control unit 84, the push-based user interface unit 20. Note that a circle mark in FIGS. 4A and 4B indicates an operating state, whereas a cross mark a stopped state. Now refer back to FIG. 1.

Based on the number of players 100 and the number of servers 200, namely based on the network configuration, detected by the network analysis unit 80, the transmitting control unit 74 determines a communication scheme to be executed between a server 200 and a targeted player 100, by referring to the switching rule stored in the switching rule storage 22. That is, the transmitting control unit 74 automatically switches the communication scheme of devices according to the network configuration, and controls its communication process.

More specifically, the switching control unit 82 selects any one of the following three schemes (1) to (3) according to the configuration of the network 300. The three schemes are (1) a scheme where the push-based communication is fixedly used, (2) a scheme where the pull-based communication is fixedly used, and (3) a scheme where the push-based communication and the pull-based communication are dynamically switched therebetween. Here, the scheme where the push-based communication and the pull-based communication are dynamically switched corresponds to the above-mentioned “first-come first-served” mode. The switching control unit 82 controls the operating states of the push-based user interface unit 20, the push control unit 86 and the passive pull control unit 84. As a result, the contents communication scheme used between the player 100 and the server 200 is switched between the pull-based and the push-based communication by controlling the switching control unit 82.

For example, if another server 200 is detected by the network detection unit 26, namely in either “Case 2” or “Case 4”, the switching control unit 82 will select the scheme where the pull-based communication is fixedly used. In accordance with a switching rule, the switching control unit 82 determines the execution of the passive pull control unit 84 and the stoppage of the push control unit 86 and the push-based user interface unit 20.

If any other server 200 is not detected and a plurality of players are detected by the network detection unit 26, namely in the “Case 3”, the switching control unit 82 will select the method where the push-based communication is fixedly used. In accordance with a switching rule, the switching control unit 82 determines the execution of the push control unit 86 and the push-based user interface unit 20 and the stoppage of the passive pull control unit 84.

If any other server 200 is not detected and a single player 100 is detected by the network detection unit 26, namely in the “Case 1”, the switching control unit 82 will select the scheme where the push-based communication and the pull-based communication are dynamically switched therebetween. When executing the push-based communication, the switching control unit 82 determines the execution of the push control unit 86 and the push-based user interface unit 20 and the stoppage of the passive pull control unit 84. When executing the pull-based communication, the switching control unit 82 determines the execution of the passive pull control unit 84 and the stoppage of the push control unit 86 and the push-based user interface 20. When the transmitting control unit 74 receives an instruction by the push-based communication user interface unit 20 described later, the transmitting control unit 74 executes the pull-based communication scheme.

The passive pull control unit 84 has the contents transmitter 76 transmit the contents according to an instruction, from a player 100 to be communicated, given via the communication interface unit 28. The push-based user interface unit 20 receives the instruction from the user. The push control unit 86 controls the push-based communication according to the received instruction. More specifically, the push-based user interface unit 20 presents to the user a list of players 100 that support the push-based communication on the network 300, receives a user's input and issues an order of the push-based communication to the push control unit 86. In response to the order of the push-based communication, the push control unit 86 has the contents transmitter 76 execute the push-based communication.

In accordance with an instruction from the transmitting control unit 74, the contents transmitter 76 transmits the contents stored in the contents storage 24 to a targeted player 100. Even when any of communication schemes is used, the contents are transferred in the order from the contents storage 24 to the contents transmitter 76. The communication interface unit 28 controls the exchange of control messages between the player 100 and the server 200. Accordingly, the communication interface unit 28 receives commands for pull-based communication from the targeted player 100. The communication interface unit 28 also transmits commands for push-based communication to the targeted player 100.

The own-device information storage 42, the network detection unit 16, the device list storage 40 and the switching rule storage 12 in the player 100 are the same as the own-device information storage 72, the network detection unit 26, the device list storage 70 and the switching rule storage 22 in the server 200, so that the repeated explanation therefor is omitted here.

While referring to the switching rules stored in the switching rule storage 22, the receiving control unit 44 determines the communication scheme employed between the player 100 and a targeted server 200, based on the number of servers 200 and the number of players 100 detected by the network analysis unit 80, namely based on the configuration of the network 300. That is, the receiving control unit 44 automatically switches the communication scheme according to the configuration of the network 300 so as to control the communication process. In so doing, similarly to the switching control unit 82, the switching control unit 52 selects any one of the method where the push-based communication is fixedly used, the method where the pull-based communication is fixedly used, and the method where the push-based communication and the pull-based communication are dynamically switched therebetween, according to the configuration of the network 300, namely “Case 1” to “Case 4”.

The communication schemes corresponding respectively to “Case 1” to “Case 4” are those described as above, so that the description thereof is omitted here. In the “Case 2” or “Case 4”, the switching control unit 52 determines the execution of the pull control unit 54 and the pull-based user interface unit 10 and the stoppage of the passive push control unit 56. In the “Case 3”, the switching control unit 52 determines the execution of the passive push control unit 56 and the stoppage of the pull control unit 54 and the pull-based user interface unit 10. In the “Case 1”, when a push-based communication is to be executed, the switching control unit 82 determines the execution of the passive push control unit 56 and the stoppage of the pull control unit 54 and the pull-based user interface unit 10. Also, in the “Case 1”, when a pull-based communication is to be executed, the switching control unit 82 determines the execution of the pull control unit 54 and the pull-based user interface unit 10 and the stoppage of the passive push control unit 56.

The pull-based user interface 10 receives instructions from the user. More specifically, the pull-based user interface unit 10 presents to the user a list of servers 200 that support the pull-based communications on the network 300, receives a user's input and issues a command of a pull-based transmission to the pull control unit 54. The pull control unit 54 performs a pull-based communication according to a user's instruction. That is, the pull control unit 54 instructs a targeted server 200 to transmit the contents. In accordance with an order of the push control unit 86, the passive push control unit 56 passively executes the push-based communication.

In accordance with a result selected by the receiving control unit 44, the contents receiver 46 receives the contents transmitted by a server 200 to be communicated. The playback unit 14 plays the contents, received by the contents receiver 46, which are images, music, videos and the like. Even when any of communication schemes is used, the contents are transferred in the order from the contents receiver 46 to the playback unit 14. The communication interface unit 18 controls the exchange of control messages between the player 100 and the server 200. That is, the communication interface unit 18 receives commands for push-based communication scheme from the targeted server 200. The communication interface unit 18 also transmits commands for pull-based communication scheme to the targeted server 200.

This structure may be implemented hardwarewise by elements such as a CPU, memory and other LSIs of an arbitrary computer, and softwarewise by memory-loaded programs having communication functions or the like. Depicted herein are functional blocks implemented by cooperation of hardware and software. Therefore, it will be obvious to those skilled in the art that the functional blocks may be implemented by a variety of manners including hardware only, software only or a combination of both.

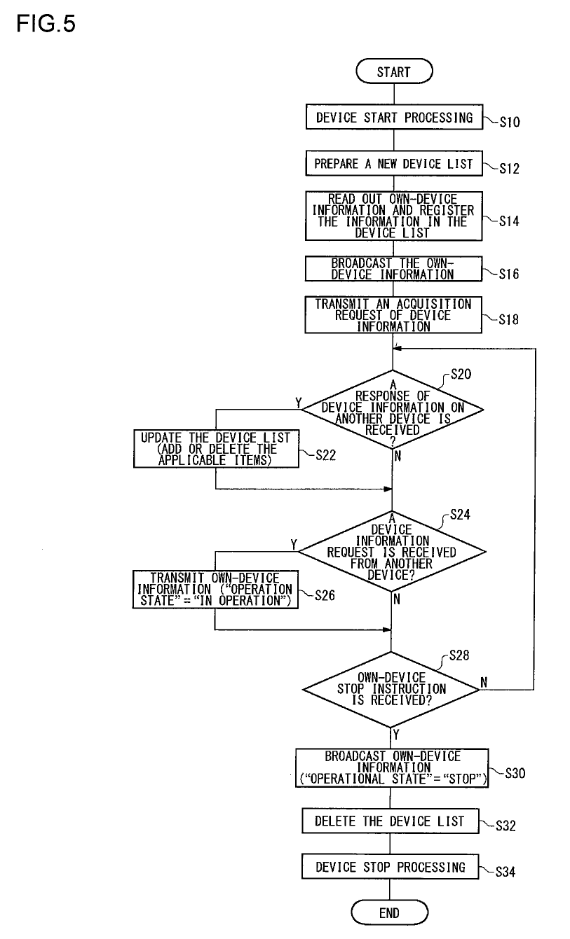

An operation of the contents communication system 1000 structured as above is now described. FIG. 5 is a flowchart showing a management procedure performed by the device management unit 50. When a device is started or participates in the network 30, the device management unit 50 or the device management unit 78 performs start processing (S10) and then reads the own-device information sent from the own-device information storage 42 or the own-device information storage 72. The device management unit 50 or the device management unit 78 prepares a new device list in the device list storage 70 (S12). At the same time, the device management unit 50 or the device management unit 78 reads out the own-device information from the own-device information storage 42 or the own-device information storage 72 and registers it in the device list (S14).

The device management unit 50 or the device management unit 78 notifies on the network 300 via the communication interface unit 18 or the communication interface unit 28 that the device management unit 50 or 78 itself is in operation (S16), and transmits an acquisition request of device information to the other devices (S18). Thereafter, if it receives a response of device information from the other devices (Y of S20), the device management unit 50 or the device management unit 78 will update the device list (S22). If the response of device information is information indication “in operation”, items related to the applicable device will be added; and if “stopped”, the applicable items will be deleted. If the response of device information on the other devices is not received (N of S20), Step 22 will be skipped.

If the communication interface unit 18 or the communication interface unit 28 receives a device information request (Y of S24), it will inform the communication party that the device itself is in operation (S26). If, on the other hand, the communication interface unit 18 or the communication interface unit 28 does not receive the device information request (N of S24), Step 26 will be skipped. If an own-device stop instruction is not received (N of 28), a return will be made to Step 20. If an own-device stop instruction is received (Y of 28), namely if the device is stopped or withdraws from the network 300, the device management unit 50 or the device management unit 78 will broadcast that the own device stops (S30) and will delete the device list (S32) so as to execute a stop processing of the device (S34).

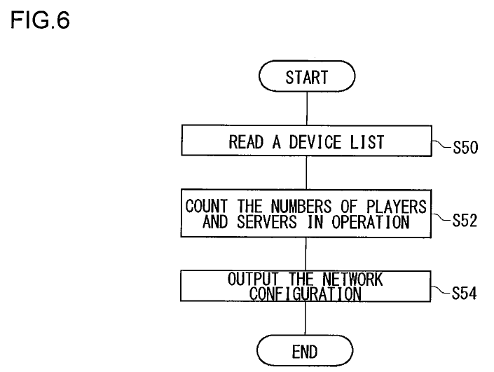

FIG. 6 is a flowchart showing an analysis procedure by the network analysis units 48 and 80. The network analysis unit 48 or the network analysis unit 80 reads the device list from the device list storage 40 or the device list storage 70 (S50). The network analysis unit 48 or the network analysis unit 80 counts the number of players 100 and the number of servers 200 in operation on the network 300 (S52). Further, based on the thus counted numbers thereof, the network analysis unit 48 or the network analysis unit 80 outputs the configuration of the network 300, namely the number of players 100 and the number of servers 200, to the switching control unit 52 (S54).

The switching control unit 52 or the switching control unit 82 reads the configuration of the network 300 from the network analysis unit 48 or the network analysis unit 80, and checks it against the switching rule of communication schemes stored in the switching rule storage 12 or the switching rule storage 22.

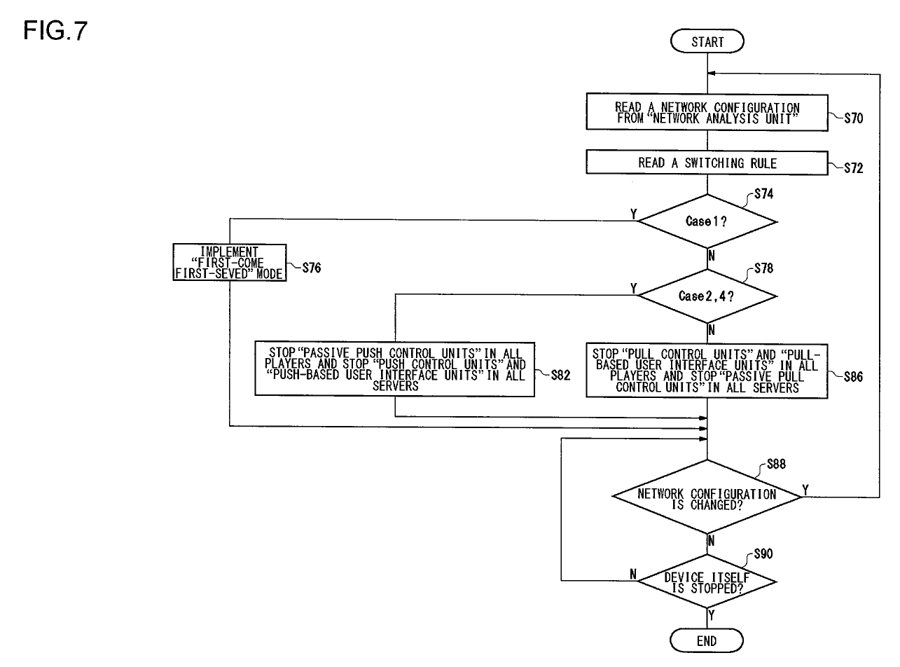

FIG. 7 is a flowchart showing a control procedure by the switching control units 52 and 82. The switching control unit 52 or the switching control unit 82 reads the configuration of the network sent from analysis unit 48 or the network analysis unit 80 (S70). Subsequently, the switching control unit 52 or the switching control unit 82 reads the switching rule of communication schemes from the switching rule storage 12 or the switching rule storage 22 (S72). If the configuration of the network 300 belongs to “Case 1” (Y of S74), the switching rule unit 52 or the switching control unit 82 will implement the “first-come first-served” mode (S76). On the other hand, if the configuration of the network 300 is not “Case 1” (N of S74) but “Case 2” or “Case 4” (Y of S78), the switching control unit 52 or the switching control unit 82 will forcibly switch the communication scheme to the pull-based communication scheme.

More specifically, the operation of the passive push control unit 56 in the player 100 or the push control unit 86 and the push-based user interface unit 20 in the server 200 are stopped (S82). That is, the network 300 is so set as to allow the pull-based communication only. On the other hand, if the configuration of the network 300 is not “Case 2” or “Case 4” (N of S78), namely in the “Case 3”, the operation of the pull control unit 54 and the pull-based user interface unit in the player 100 or the operation of the passive pull control unit 84 in the server 200 will be stopped (S86). That is, the network 300 is so set as to allow the push-based communication only. If the network 300 changes (Y of S88), a return will be made to Step 70. If the network 300 does not change (N of S88) and the device itself does not stop (N of S90), a return will be made to Step 88. If the device itself stop (Y of S90), the processing will end.

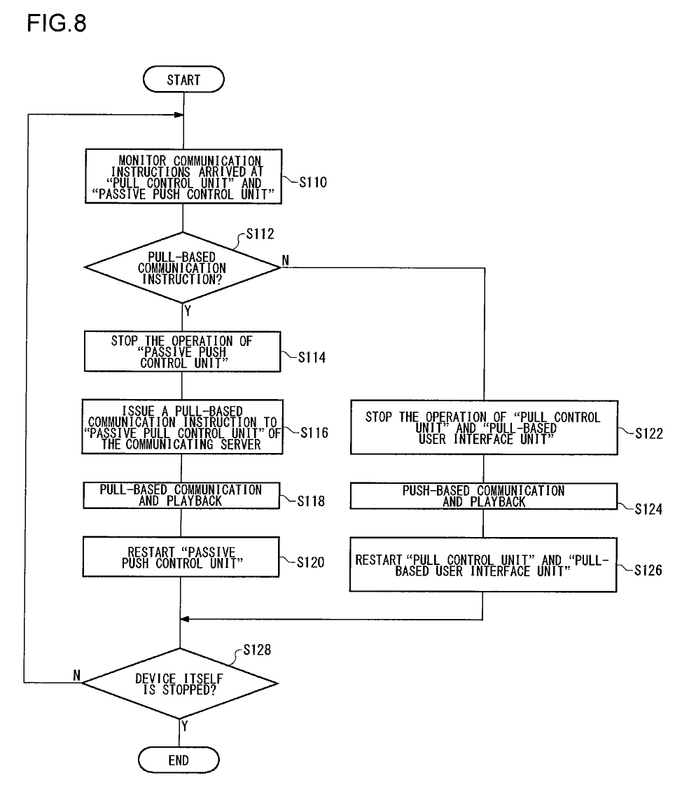

FIG. 8 is a flowchart showing an operational procedure performed when the “first-come first-served” mode is set by the player 100. The switching control unit 52 monitors the pull control unit 54 and the passive push control unit 56, and detects if a transfer instruction has arrived from the pull-based user interface 10 or the server 200 (S110). If the detected instruction is a pull-based communication instruction (Y of S112), the switching control unit 52 will stop the operation of the passive push control unit 56 (S114) and thereby the setting is adjusted such that any push-based communication instruction coming from the push control unit 86 in the server 200 cannot be received. Also, the pull control unit 54 issues a pull-based communication instruction to the passive pull control unit 84 in the server 200 (S116) and has it start pull-based communication and playback (S118). When the pull-based communication is over, the switching control unit 52 restarts the passive push control unit 56 (S120) and the setting is adjusted so that push-based communication can be received.

On the other hand, if the detected instruction is not the pull-based communication instruction (N of S112), namely, if it is a push-based communication instruction, the switching control unit 52 will stop the operation of the pull control unit 54 and the pull-based user interface unit 10 (S122), adjust the setting such that any pull-based communication instruction from the user be not accepted and then perform the push-based communication and playback according to an instruction from the push control unit 86 in the server 200 (S124). When the push-based communication and playback are over, the switching control unit 52 restarts the pull control unit 54 and the pull-based user interface unit 10 (S126) and the setting is adjusted so that pull-based communication can be received. If the device itself is not stopped (N of S128), a return will be made to Step 110. On the other hand, when the device itself is stopped (Y of S128), the processing ends.

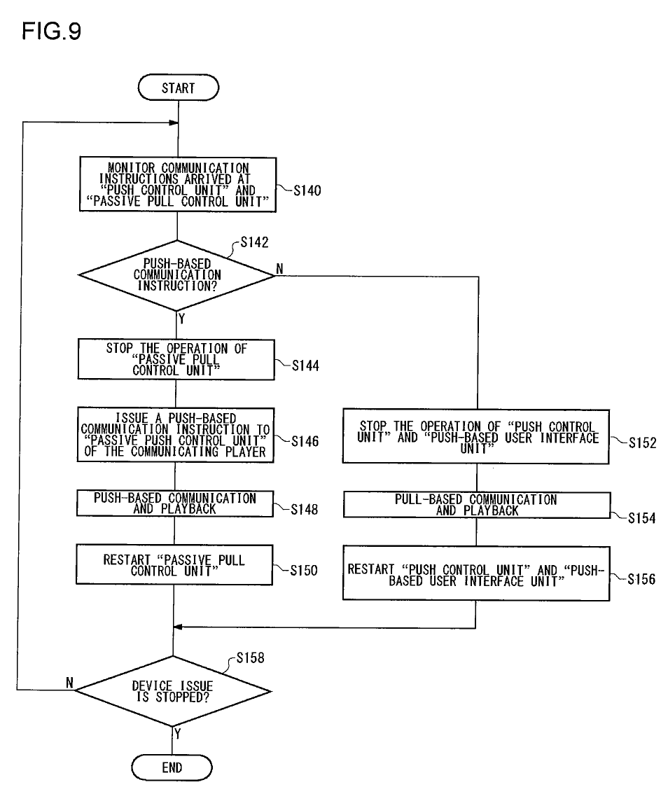

FIG. 9 is a flowchart showing an operational procedure performed when the “first-come first served” mode is set by the server 200. The switching control unit 82 monitors the push control unit 86 and the passive pull control unit 84, and detects if a transfer instruction has arrived from the push-based user interface 20 or the player 100 (S140). If the detected instruction is a push-based communication instruction (Y of S142), the switching control unit 82 will stop the operation of the passive pull control unit 84 (S144) and thereby the setting is adjusted such that any pull-based communication instruction coming from the pull control unit 54 in the player 100 cannot be received. Also, the push control unit 86 issues a push-based communication instruction to the passive push control unit 56 in the player 100 (S146) and has it start push-based communication and playback (S148). When the push-based communication is over, the switching control unit 82 restarts the passive pull control unit 84 (S150) and the setting is adjusted so that pull-based communication can be received.

On the other hand, if the detected instruction is not the push-based communication instruction (N of S142), namely, if it is a pull-based communication instruction, the switching control unit 82 will stop the operation of the push control unit 86 and the push-based user interface unit 20 (S152), adjust the setting such that any push-based communication instruction from the user be accepted and then perform the pull-based communication and playback according to an instruction from the pull control unit 54 in the player 100 (S154). When the pull-based communication and playback are over, the switching control unit 82 restarts the push control unit 86 and the push-based user interface unit 20 (S156) and the setting is adjusted so that push-based communication can be received. If the device itself is not stopped (N of S158), a return will be made to Step 140. On the other hand, when the device itself is stopped (Y of S158), the processing ends.

A modification of the exemplary embodiment will now be described hereinbelow. In this modification, the switching rules stored in switching rule storage 12 and the switching rule storage 22 differ from those in the exemplary embodiments. For example, in order to further enhance the flexibility of the contents communication system 1000, it is only necessary to employ the “first-come first-served” mode in all of “Case 2” to “Case 4”.

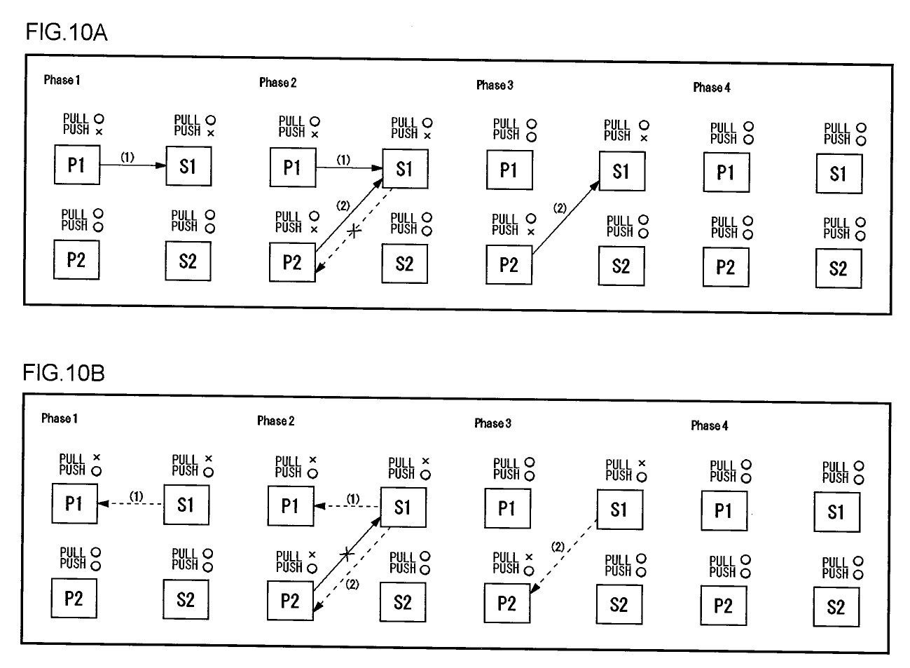

FIGS. 10A and 10B illustrate an outline of operation carried out when the “first-come first-served” mode is set in Case 4 of FIG. 3D. FIG. 10A illustrates a case where a pull-based communication (1) first occurs between a player P1 and a server S1. In a Phase 1, each module of P1 and S1 is automatically set so that the P1 and S1 will permit the pull-based communication and reject the push-based communication. During a period of a Phase 2 in which the communication of (1) takes place, the pull-based communication (2) from another player P2 to the server S1 is permitted but the push-based communication from the server S1 to the player P2 is not permitted.

In a communication that takes place between devices other than the player P1 and the server S1, the “first-come first-served” mode employed in the pull-based communication and the push-based communication automatically determines a transmission mode as shown in the Phase 1 without the above-described constraint. If, in a Phase 3, the communication (1) is terminated and the communication (2) is still in progress, the push-based communication function of the player P1 only will be restored. If all the communications are terminated in a Phase 4, the push-based communication of the server S1 will also be restored.

FIG. 10B illustrates a case where a push-based communication (1) first occurs between a player P1 and a server S1. In a Phase 1, each module of P1 and S1 is automatically set so that the P1 and S1 will permit the push-based communication and reject the pull-based communication. During a period of a Phase 2 in which the communication of (1) takes place, the push-based communication (2) is not allowed between the server S1 and another player P2. Note that a communication taking place between devices other than the player P1 and server S1 is not subject to this constraint. If, in the Phase 3, the communication (1) is terminated and the communication (2) is in progress, the pull-based communication function of the player P1 only will be restored. If all the communications are terminated in the Phase 4, the pull-based communication of the server S1 will also be restored.

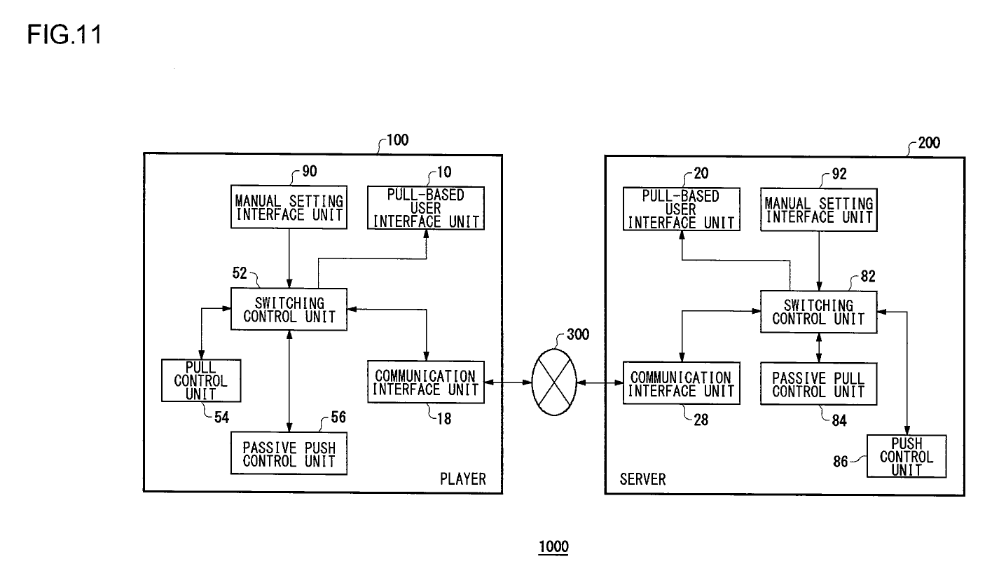

Another modification of the exemplary embodiment will now be described hereinbelow. In the above exemplary embodiment, the push-based communication and the pull-based communication are automatically switched therebetween. On the other hand, in another modification, the push-based communication and the pull-based communication are manually switched. FIG. 11 illustrates a structure of a contents communication system 1000 according to another modification of the exemplary embodiment. Of constituting elements shown in FIG. 11, those which have already been shown in FIG. 1 are given the same reference numerals as those shown in FIG. 1. A manual setting interface unit 90 and a manual setting interface unit 92 are provided in the player 100 and the server 200, respectively. When the manual setting interface units 90 and 92 receive a manual switch instruction from the user, they output the instruction to the switching control unit 52 or the switching control unit 82. The switching control unit 52 or the switching control unit 82 sets the operating states of each control module and the user interface according to the user's instruction. Thereby it is possible to set three communication modes which are a manually set pull-based communication mode, a manually set push-based communication mode and an automatically set communication mode.

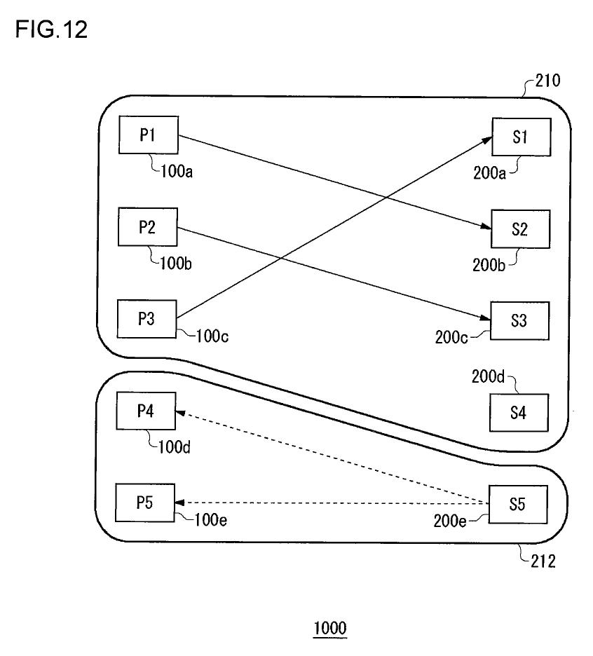

Still another modification of the exemplary embodiment will now be described hereinbelow. In the exemplary embodiments described so far, the push-based communication or the pull-based communication is defined for the entire contents communication system 1000. On the other hand, in this still another modification, the contents communication system 1000 is divided into a plurality of groups, and the push-based communication or the pull-based communication system is defined for each of the groups. FIG. 12 illustrates a structure of a contents communication system 1000 according to still another modification of the exemplary embodiment. The contents communication system 1000 includes a first player 100a to a fifth player 100e, which are generically referred to as “player 100”, and a first server 200a to a fifth server 200e, which are generically referred to as “server 200”. As shown in FIG. 12, the contents communication system 1000, which includes a plurality of players 100 and a plurality of servers 200, corresponds to “Case 4” as shown in FIG. 3D in which case the pull-based communication is forcibly executed.

The first player 100a to the third player 100c and the first server 200a to the fourth server 200d out of the devices contained in the contents communication system 1000 shown in FIG. 12 constitute a first group 210. The fourth player 100d, the fifth player 100e and the fifth server 200e out of the devices contained in the contents communication system 1000 constitute a second group 212. That is, the contents communication system 1000 is divided into two groups of the first group 210 and the second group 212. Here, the first group 210, which includes three players 100 and four servers 200, corresponds to Case 4. On the other hand, the second group 212, which includes two players 100 and one server 200, corresponds to Case 3. Accordingly, the pull-based communication is forcibly executed in the first group 210, whereas the push-based communication is forcibly executed in the second group 212. In this manner, a different mode of communication is executed for each group in the contents communication system 1000.

The structures of players 100 and servers 200 are of the same type as those shown in FIG. 1. The own-device information storage 72 also records information with which to identify a group belonging to its own device (hereinafter referred to as “group information”). The group information is indicated by a group identification number “1”, a group identification number “2” and so forth, for example. The group identification numbers are preferably inputted directly by the user. Or if the contents are video data, the group identification numbers may be defined according to the bit rate of video data. For example, the contents whose bit rate is 100K bps are associated with the group number “1”, and the contents whose bit rate is 1M bps are associated with the group identification number “2”. The own-device information storage 72 receives the information on the rate from the user and converts the received information into group information so as to be stored therein. The device management unit 78 reads information on its own device and the group information from the own-device information storage 72 and then conveys these pieces of information on the network 300 via the communication interface unit 28. The device management unit 78 also gathers information on other devices on the network 300 via the communication interface unit 28. Further, based on the gathered information on the devices, the device management unit 78 updates the device list stored in the device list storage 70.

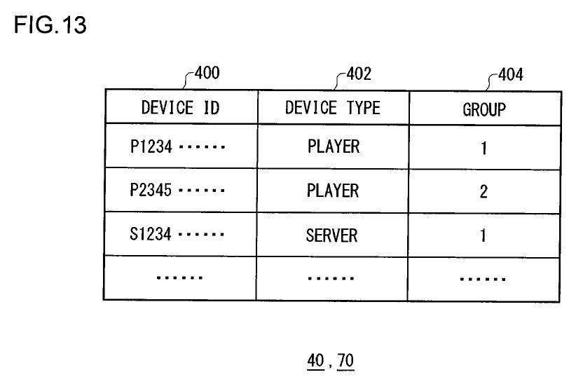

FIG. 13 illustrates a data structure of a device list stored in a device list storage 70 according to still another modification of an exemplary embodiment. In the device list shown in FIG. 13, a group column 404 is added to the device list of FIG. 2. The group column 404 indicates the group identification number corresponding to each device. Refer back to FIG. 1. The network analysis unit 80 analyzes the configuration of the network 300. More specifically, the network analysis unit 80 derives the number of players 100 and the number of servers 200 having the same identification number as its own group identification number by referring to the device list stored in the device list storage 70, thereby deriving the configuration of the network 300. Further, the network analysis unit 80 outputs the thus derived results to the control unit 74. The transmitting control unit 74 classifies each group into any one of “Case 1” to “Case 4”.

The own-device information storage 42, the network detection unit 16, the device list storage 40, the switching rule storage 12 and the receiving control unit 44 in the player 100 are similar to the own-device information storage 72, the network detection unit 26, the device list storage 70, the switching rule storage 22 and the transmitting control unit 74 in the server 200.

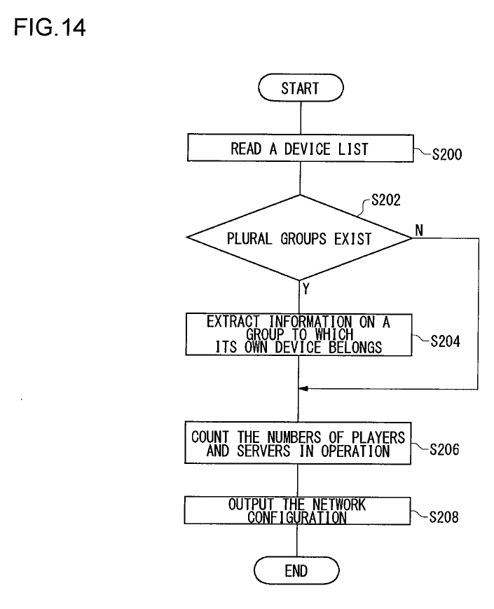

FIG. 14 is a flowchart showing an analysis procedure performed by the network analysis units 48 and 80 according to still another modification of the exemplary embodiment. The network analysis 48 or the network analysis unit 80 reads a device list from the device list storage 40 or the device list storage 70 (S200). If a plurality of groups exist on the network (Y of S202), the network analysis unit 48 or the network analysis unit 80 will extract information on a group to which its own device belongs (S204). On the other hand, if there is only one group existing on the network (N of S202), Step 304 will be skipped. The network analysis unit 48 or the network analysis unit 80 counts the number of players 100 and the number of servers 200 in operation on the network 300 (S206). Further, based on the thus counted numbers thereof, the network analysis unit 48 or the network analysis unit 80 outputs the configuration of the network 300, namely the number of players 100 and the number of servers 200, to the switching control unit 52 (S208).

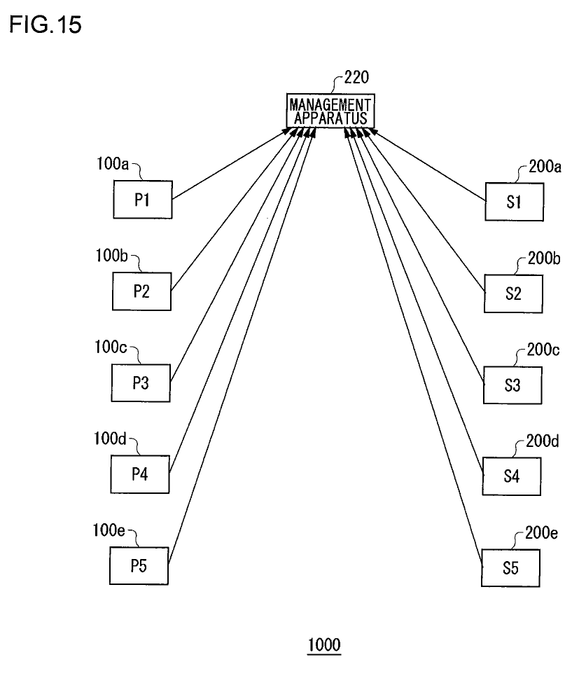

Still another modification of the exemplary embodiment will now be described hereinbelow. In this modification, too, a plurality of groups are included in a contents communication system 1000. The groups are managed by a management apparatus. FIG. 15 illustrates a structure of the contents communication system 1000 according to this still another modification of the exemplary embodiment. In the contents communication system 1000 shown in FIG. 15, a management apparatus 220 is newly added to the structure shown in FIG. 12. The management apparatus 220 receives device information from the player 100 and/or the server 200. The management apparatus 220 generates a device list as shown in FIG. 2, based on the received information. The management apparatus 220 receives group specifying information for each device, from the user. As a result, the device list as shown in FIG. 2 is updated to the device list as shown in FIG. 13. The management apparatus 220 sends the thus updated device list to the player 100 and the server 200. The player 100 and the server 200 store the device lists in the device list storage 70 or the derive list storage 70. The processing after this Step is the same as the above-described processing and thus the repeated explanation is omitted here.

According to the exemplary embodiment of the present invention, the communication scheme used between a server and a player is selected in response to the number of servers and the number of players working on the network. Hence, the communication scheme used in transmitting the contents can be easily switched. Any one of three schemes which are (1) a method where the pull-based communication is fixedly used, (2) a method where the push-based communication is fixedly used and (3) a method where either the push-based communication or the pull-based communication is dynamically switched is automatically selected. Hence, the compatibility between the push-based communication and the pull-based communication can be easily achieved.

When a plurality of servers are detected, the pull-based communication is fixedly used. As a result, disruption and confusion caused by the push-based communication simultaneously performed from a plurality of servers to a player can be prevented. When there is a single server and there are a plurality of players, the push-based communication is used. Thus the disruption and confusion can be prevented by performing communication under control of a single server. The push-based communication and the pull-based communication are dynamically switched therebetween according to instructions. Thus, various communication schemes can be flexibly dealt with. Even when a plurality of groups are contained in the contents communication system, either the push-based communication or the pull-based communication is determined for each of the groups. Thus, a processing suitable for each group can be executed.

The description of the invention given above is based upon illustrative embodiments. These exemplary embodiments are intended to be illustrative only and it will be obvious to those skilled in the art that various other modifications to constituting elements and processes could be developed and that such modifications are also within the scope of the present invention.

In the exemplary embodiment of the present invention, the players 100 and the servers 200 are compatible with the pull-based communication and the push-based communication. However, the exemplary embodiment is not limited thereto and, for example, the player 100 or the server 200 compatible with the pull-based communication or the push-based communication may be included in the contents communication system 1000. When conveying information on its own device, such a player 100 or server 200 also conveys information indicating that its own device is compatible with the pull-based communication or the push-based communication. As a result, the rules defined in Case 1 through Case 4 are ignored and a communication conforming to a player 100 or a server 200 compatible with either one of the pull-based communication and the push-based communication is executed. For example, when a player 100 compatible with the pull-based communication only is included even in the case like Case 3, the pull-based communication is executed. Also, when a server 200 compatible with the push-based communication only is included even in the case like Case 2, the push-based communication is executed. According to this modification, even when a player 100 or a server 200 compatible with either one of the pull-based communication and the push-based communication is included in the contents communication system 1000, the communication can still be executed.

In the exemplary embodiment of the present invention, the contents communication system 1000 selects the pull-based communication or push-based communication. However, the exemplary embodiment is not limited thereto, and other communications than these may be selected. More specifically, two kinds of pull-based communications are defined, and the contents communication system 1000 selects either one of them. The first one, which will be referred to as “first pull-based communication”, is a pull-based communication started by the server 200. Upon receipt of an instruction from the user, the server 200 conveys it to the player 100 accordingly. Then the player 100 requests the server 200 to transmit the contents, and the server 200 transmits the contents to the player 100. That is, the first pull-based communication is equivalent to a processing where a pull-based communication is performed finally and the first instruction is received in a transmitting side. On the other hand, the second one, which will be referred to as “second pull-based communication”, is a pull-based communication started by the player 100. This second pull-based communication is the same as the pull-based communication described above and the repeated description is omitted here.

The structure of the contents communication system 1000 according to this modification has the same structure as the contents communication system 1000 shown in FIG. 1. Note that “push” indicated in FIG. 1 and the description regarding it may be replaced by “first pull”, whereas “pull” indicated in FIG. 1 may be replaced by “second pull”. However, a description is given hereinbelow in the same manner as before. The arrow pointing toward the passive push control unit 56 from the communication interface unit 18 is replaced by a two-way arrow. And the arrow pointing toward the communication interface unit 28 from the push control unit 86 is replaced by a two-way arrow. A description is now given hereinbelow of a difference, particularly centering around the first pull-based communication. As described before, the push-based user interface unit 20 receives an instruction from the user.

The push control unit 86 transmits the received instruction to the player 100 via the communication interface unit 28. The passive push control unit 56 receives an instruction from the server 200, via the communication interface unit 18. Then the passive push control unit 56 requests, via the communication interface unit 28, the server 200 to transmit the contents the same way as the pull control unit 54. The push control unit 86 receives a transmission request from the player 100 via the communication interface unit 28. Similarly to the passive pull control unit 84, the push control unit 86 has the contents transmitter 76 transmit the contents according to the request. By implementing this modification, the present exemplary embodiments can be applied to various type of communications.

While the preferred embodiments of the present invention have been described using specific terms, such description is for illustrative purposes only, and it is to be understood that changes and variations may be further made without departing from the spirit or scope of the appended claims.

What is claimed is:

1. A contents receiving apparatus for receiving, via a network, contents transmitted by a targeted contents transmitting apparatus, the contents receiving apparatus comprising:
a detector which detects the number of contents transmitting apparatuses and the number of other contents receiving apparatuses in operation on the network;
a selector which selects, as a communication scheme used between said contents receiving apparatus and the targeted contents transmitting apparatus, any one of a scheme where a first pull-based communication started by the contents transmitting apparatus is fixedly used, a scheme where a second pull-based communication started by said contents receiving apparatus is fixedly used, and a scheme where the first pull-based communication and the second pull-based communication are dynamically switched therebetween; and
an execution unit which receives the contents transmitted by the targeted contents transmitting apparatus according to a result selected by said selector.

2. A contents receiving apparatus according to claim 1, wherein when a plurality of contents transmitting apparatuses are detected by said detector, said selector selects the scheme where the second pull-based communication is fixedly used, and
wherein said execution unit instructs the targeted contents transmitting apparatus to transmit the contents.

3. A contents receiving apparatus according to claim 1, wherein when a single contents transmitting apparatus and at least one other contents receiving apparatus are detected by said detector, said selector selects the scheme where the first pull-based communication is fixedly used.

4. A contents receiving apparatus according to claim 1, further comprising:
a first receiving unit which receives an instruction from a user; and
a second receiving unit which receives from a targeted contents transmitting apparatus an instruction on a communication scheme to be executed,
wherein when a single contents transmitting apparatus is detected and other contents receiving apparatuses are not detected by said detector, said selector selects the scheme where the first pull-based communication and the second pull-based communication are dynamically switched therebetween and
wherein when the scheme where the first pull-based communication and the second pull-based communication are dynamically switched therebetween is selected by said selector and the instruction is received by said first receiving unit, said execution unit executes the second pull-based communication as the communication scheme; and when the scheme where the first pull-based communication and the second pull-based communication are dynamically switched therebetween is selected by said selector and the instruction is received by said second receiving unit, said execution unit executes the first pull-based communication as the communication scheme.

5. A contents transmitting apparatus for transmitting contents to a targeted contents receiving apparatus via a network, the contents transmitting apparatus comprising:
a detector which detects the number of contents receiving apparatuses and the number of other contents transmitting apparatuses in operation on the network;
a selector which selects, as a communication scheme used between said contents transmitting apparatus and the targeted contents receiving apparatus, any one of a scheme where a first pull-based communication started by said contents transmitting apparatus is fixedly used, a scheme where a second pull-based communication started by the contents receiving apparatus is fixedly used, and a scheme where the first pull-based communication and the second pull-based communication are dynamically switched therebetween, based on the number of contents receiving apparatuses and the number of other contents transmitting apparatuses detected by said detector; and
an execution unit which transmits the contents to the targeted contents receiving apparatus according to a result selected by said selector.

6. A contents transmitting apparatus according to claim 5, wherein when another contents transmitting apparatus is detected by said detector, said selector selects the scheme where the second pull-based communication is fixedly used, and
wherein said execution unit transmits the contents according to an instruction from the targeted contents receiving apparatus.

7. A contents transmitting apparatus according to claim 5, wherein when any other contents transmitting apparatus is not detected and a plurality of contents receiving apparatuses are detected by said detector, said selector selects the scheme where the first pull-based communication is fixedly used.

8. A contents transmitting apparatus according to claim 5, further comprising:
a first receiving unit which receives an instruction from a user; and
a second receiving unit which receives from a targeted contents receiving apparatus an instruction on a communication scheme to be executed,
wherein when any other contents transmitting apparatus is not detected and a single receiving apparatus is detected by said detector, said selector selects the scheme where the first pull-based communication and the second pull-based communication are dynamically switched therebetween, and
wherein when the scheme where the first pull-based communication and the second pull-based communication are dynamically switched therebetween is selected by said selector and the instruction is received by said first receiving unit, said execution unit executes the first pull-based communication as the communication scheme; and when the scheme where the first pull-based communication and the second pull-based communication are dynamically switched therebetween is selected by said selector and the instruction is received by said second receiving unit, said execution unit executes the second pull-based communication as the communication scheme.

9. A contents communication method, wherein any one of a scheme where a first pull-based communication started by a contents transmitting apparatus is fixedly used, a scheme where a second pull-based communication started by a contents receiving apparatus is fixedly used, and a scheme where the first pull-based communication and the second pull-based communication are dynamically switched therebetween is selected as a communication scheme used when contents are transmitted from the contents transmitting apparatus to the contents receiving apparatus, based on the number of contents transmitting apparatuses and the number of other contents receiving apparatuses in operation on a network.
